(19) United States
(12) Patent Application Publication
(10) Pub. No.: US 2001/0044829 A1
(43) Pub. Date: Nov. 22, 2001

(54) REMOTE E-MAIL MANAGEMENT AND COMMUNICATION SYSTEM

(76) Inventor: DAVID LUNDBERG, DUBLIN, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/434,674

(22) Filed: Nov. 5, 1999

(51) Int. Cl. G06F 15/16

(52) U.S. Cl. 709/206; 709/329

(57) ABSTRACT

A system and method for routing e-mail attachment files within a computer system are described. In one embodiment, the system ascertains the type of file for the attachment file based upon content of the attachment file. In addition, if the attachment file is not a text-based file type, the system routes the attachment file to an appropriate application program based upon the type of the attachment file. In one embodiment, the system launches the application program in response to the receipt of the attachment file. In an alternate embodiment, the system receives notice that an attachment file has been received, and sends the file to the appropriate application program in response to a trigger event.

### FIELD OF THE INVENTION

The present invention relates to networked terminals that provide access to network resources. More particularly, this invention relates to a remote e-mail management and communication system.

### BACKGROUND OF THE INVENTION

Efficient techniques for accessing and utilizing information are important considerations for manufacturers, designers and individual users of modern electronic information systems. Sources of electronically available information include various types of electronic networks, such as the Internet, which are typically accessible through a compatible computer device or other similar electronic system. With the increased use of the Internet as a means for communication, the use of electronic mail (e-mail) for business and personal communications has rapidly increased.

Traditional e-mail systems have been text base rather than graphics based. However, e-mail systems have developed to include a variety of types of non-text data in the form of attachments or separate files. To send a graphic file with an e-mail message, the system user typically electronically attaches the graphic file to the e-mail document in order to create an attachment file. Once the e-mail with attachment is received by a user, the user must open the e-mail client program and access the attachment file from within the e-mail client The e-mail client or the underlying operating system then launches the appropriate application, typically in a newly created or separate window, in order for the viewer to access the attachment file. Alternatively, the user may save the attachment file for later retrieval.

In order to access the attachment file, the user may open an application program in a separate window and subsequently open the attachment file within the application. In order for the user to open the appropriate application, the user must know before hand the type of the attachment file. The user must know the type of attachment file either by a file extension or by the sender of the file notifying the user by, for example, in writing or verbally.

Alternatively, the user may access the attachment file directly by “clicking” on the file name which causes the operating system or file system of the user's client to open the application in a separate window. Subsequently, the application automatically opens the attachment file. For the operating system of file system to open the proper application, the system must recognize the file type extension of the attachment file. In addition, the extension must have been associated with the particular application prior to access by the system.

### SUMMARY OF THE INVENTION

A system and method for routing e-mail attachment files within a computer system are described. In one embodiment, the system ascertains the type of file for the attachment file based upon content of the attachment file. In addition, if the attachment file is not a text-based file type, the system routes the attachment file to an appropriate application program based upon the type of the attachment file. In one embodiment, the system launches the application program in response to the receipt of the attachment file. In an alternate embodiment, the system receives notice that an attachment file has been received, and sends the file to the appropriate application program in response to a trigger event.

### BRIEF DESCRIPTION OF THE DRAWINGS

The present invention is illustrated by way of example, and not by way of limitation in the figures of the accompanying drawings, in which like references indicate similar elements and in which:

FIG. 1 is a block diagram of one embodiment for a network configuration of an e-mail attachment file routing system;

FIG. 2 is a block diagram of one embodiment for a network operations center of FIG. 1.

FIG. 3 is a block diagram of one embodiment of an architecture for a client;

FIG. 4 is a block diagram of one embodiment for a random accesses memory of FIG. 3;

FIG. 5 is a layout of one embodiment for a graphical user interface of an e-mail attachment file routing system; and

FIG. 6 is a flow diagram of one embodiment for routing e-mail attachment files.

### DETAILED DESCRIPTION

A system and method for implementing a remote management and communication system are described. In one embodiment, the system ascertains the type of file for the attachment file based upon content of the attachment file. In addition, if the attachment file is not a text-based file type, the system routes the attachment file to an appropriate application program based upon the type of the attachment file. In one embodiment, the system launches the application program in response to the receipt of the attachment file. In an alternate embodiment, the system receives notice that an attachment file has been received, and sends the file to the appropriate application program in response to a trigger event.

In the following description, for purposes of explanation, numerous specific details are set forth in order to provide a thorough understanding of the present invention. It will be apparent, however, to one skilled in the art that the present invention can be practiced without these specific details. In other instances, structures and devices are shown in block diagram form in order to avoid obscuring the present invention.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

In the following detailed description of the present invention, numerous specific details are set forth in order to provide a thorough understanding of the present invention. However, it will be apparent to one skilled in the art that the present invention may be practiced without these specific details. In some instances, well-known structures and devices are shown in block diagram form, rather than in detail, in order to avoid obscuring the present invention. Although the description that follows describes the embodiments in terms of a web site, the embodiments are not so limited and may be practiced with any displayable information.

Some portions of the detailed descriptions which follow are presented in terms of algorithms and symbolic representations of operations on data bits within a computer memory These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise throughout the following discussion, terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

The present invention allows a user of a networked device, such as a computer system or a set-top box, to have access privileges based on user identity and the network device (e.g., terminal) used to access the network. In one embodiment, authorized users of the network have a user identity (e.g., login name and password) that identifies the user. Each authorized user of the network has a set of user privileges. The user privileges identify local resources (e.g., applications, media files) and network resources (e.g., World Wide Web pages, communications protocols, content channels) that are available to the user. In one embodiment, user access to particular applications, whether local or remote, are determined based on whether the user is current in access fees (i.e., billing status), if the resource is otherwise available to the user and the terminal being used.

In one embodiment, each device connected to the network has an associated set of device privileges that identify local resources and network resources that are provided by the device. When an authorized user of the network logs in at a terminal, that user is provided with session privileges that are the intersection of the individual user privileges and the device privileges of the device on which the user is logged in. Thus, a consistent, but not necessarily constant, set of access privileges can be provided to users regardless of the device used to access the individual resources. In other words, the user has access to all resources that the user has rights to, so long as those resources are available (based both on technical availability and usage policy) to the specific terminal being used regardless of the terminal being used and the location of the terminal.

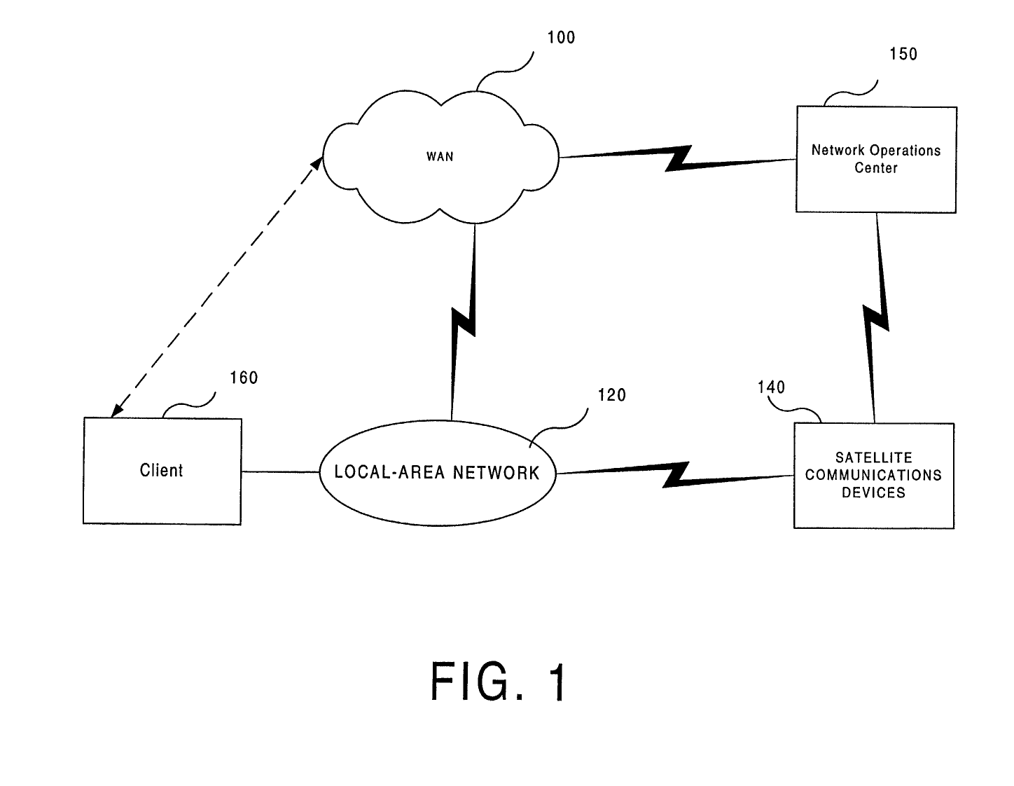

FIG. 1 is a block diagram of one embodiment for a network configuration of an e-mail attachment file routing system. The configuration of FIG. 1 is described in terms of both land-based communications and satellite communications; however, the manner of communication is not central to the present invention. Therefore, the present invention is applicable to any interconnection of devices that provide access to local and remote resources.

Referring to FIG. 1, wide area network (WAN) 100 provides an interconnection between local-area network 120, client 160, and network operations center 150. In alternate embodiments, any number of local-area networks 120, clients 160, and network operations center 150 may be connected to WAN 100. In one embodiment, WAN 100 is the Internet; however, any network or other interconnection may be used to implement wide area network 100.

In one embodiment, client 160 may be an individual terminal that provides access to network resources as well as local resources for a network user. In one embodiment, client 160 is a personal computer connected to wide area network 100 via a modem, a wireless connection, etc. In an alternate embodiment, client 160 may be a set-top box which may use a cable modem to access the WAN 100. In another embodiment, client 160 may be a “dumb” terminal, or a thin client device such as the ThinSTAR™ available from Network Computing Devices, Inc. of Mountain View, Calif.

Local-area network 120 provides an interconnection of devices at a local level. For example, local-area network 120 may interconnect multiple computers, printers, and other devices within one or more buildings. Local-area network 120 may be coupled to wide area network 100 or to satellite communications device 140. Local-area network 130 provides an interconnection of devices. In one embodiment, local-area network 120 contains a proxy server (not shown) for duplicating operations of network operations center 150.

Network operations center 150 is coupled to wide area network 100 and provides access to network resources for client 160 and local-area network 120. Network communications center 150 communicates via wide are network 100 with either client 160 or local-area network 120. Network operations center 150 and local-area network 120 may communicate via wide area network 100 and/or satellite communications devices 140.

In one embodiment, network operations center 150 includes multiple servers (not shown in FIG. 1) that provide access to network and other resources. For example, network operations center 150 may include a Web proxy server that provides access to the World Wide Web (WWW, or the Web) for devices of local-area network 120, and client 160. Network operations center 150 may also include other devices, such as, for example, a middleware server or a file server, that provide information to devices coupled to network operations center 150.

In one embodiment, information is communicated between network operations center 150 and local-area network 120 via satellite communications devices 140. Satellite communications devices 140 includes the necessary components to provide communications between network operations center 150 and local-area network 120. In one embodiment, satellite communications may be accomplished using Transmission Control Protocol/Internet Protocol (TCP/IP) embedded within a Digital Video Broadcast (DVB) stream. In alternate embodiments, any well-known communication protocol can be used. In one embodiment, satellite communications are bi-directional. Alternatively, if satellite communications are unidirectional, wide area network 100 may be used to provide a hybrid asymmetrical bi-directional communications system, such as the SkySurfer™ platform available from Gilat Satellite Networks, Inc. of McLean, Va.

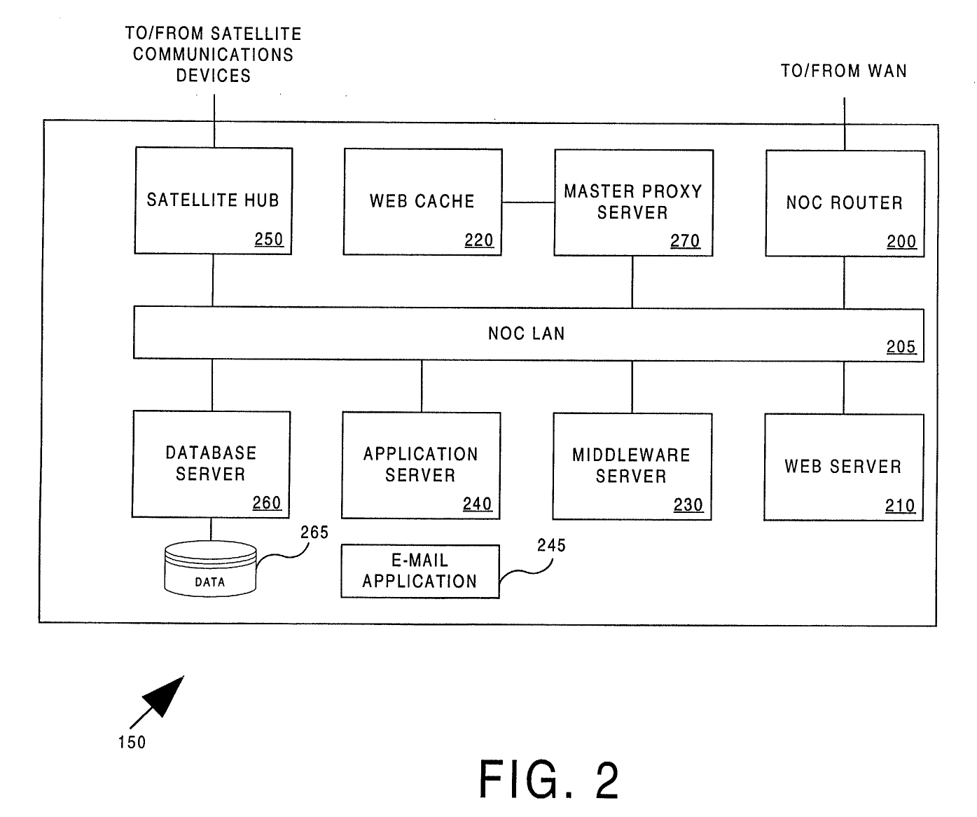

FIG. 2 is a block diagram of one embodiment for a network operations center 150. With respect to description of FIG. 2, wide area network 100 and satellite communications devices 140 are implemented as described above in FIG. 1. Notwithstanding being described as including certain types of servers and other devices, network operations center 150 may include different or additional components as well as multiple components, for example, multiple Web servers. Each server may be composed of one or more software and/or hardware components.

Network operations center (NOC) 150 provides resources to local-area networks and individual clients (not shown). In addition, in one embodiment, NOC 150 may provide a gateway to a larger network such as, for example, the Internet. Thus, network operations center 150 may be used to provide a controlled set of resources while being part of a larger network. This is particularly advantageous in situations where users of the local-area networks are somewhat homogenous. For example, students in similar grade levels, professionals, and other groups.

Additional uses and details of network operations center configuration may be found in U.S. patent application Ser. No. 09/XXX,XXX (P001), entitled “OPTIMIZING BANDWIDTH CONSUMPTION FOR DOCUMENT DISTRIBUTION OVER A MULTICAST ENABLED WIDE AREA NETWORK” and U.S. patent application Ser. No. 09/XXX,XXX (P002), entitled “A METHOD AND APPARATUS FOR. SUPPORTING A MULTICAST RESPONSE TO A UNICAST REQUEST FOR DATA,” both of which are assigned to the corporate assignee of the present invention.

Referring again to FIG. 2, NOC router 200 is coupled to NOC LAN 205 and provides routing and firewall functionality for the servers and other components of network operations center 150. NOC router 200 may be implemented in any manner known in the art. In one embodiment, database 260 is coupled to NOC LAN 205. Database 260 may be used, for example, to store information about authorized users of associated local-area networks, or to store information about resources that are available on each terminal connected to the network. Database 260 may also be used to store statistics about network usage, advertisements to be downloaded to devices of the local-area networks, etc. Data 265 represents data stored by database 260 and may be one or more physical devices

Master proxy server 270 is also coupled to NOC LAN 205 to provide World Wide Web resources to devices of the connected local-area network(s) or individual clients. In one embodiment, web server 210 is a Hypertext Markup Language (HTML) and/or Secure Sockets Layer (SSL) server. In alternate embodiments, Web server 210 may be any other suitable server. Web cache 220 is used to store Web resources (e.g., Web pages) that are most often accessed, most recently accessed, etc. In one embodiment, Web cache 220 stores a predetermined set of Web resources that are provided to the local-area networks. For example, in a school network environment, the cached Web resources may be a pre-approved set of Web pages. In one embodiment, all or a portion of the contents of Web cache 220 are replicated on local networks.

Middleware server 230 manages database applications in network operations center 150. For example, middleware server 230 may determine which users have access to Web server 210. By querying the user database, middleware server 230 acts as an interface between clients and servers as well as between servers. Alternatively, each client and server may act as its own middleware device by interfacing with the database servers on their own behalf though existing database interfacing technologies such as the Common Object Request Broker Architecture (CORBA) as defined by Object Management Group, Inc. of Framingham, Mass. or COM+available from Microsoft Corporation of Richmond, Wash.

Application server 240 provides applications programs to devices coupled to network operations center 150. For example, application server 240 may provide HTML-formatted e-mail services, via e-mail application 245, to one or more devices. E-mail application 245 includes a series of instructions which are executable by application server 240 to advantageously transmit e-mail formatted messages and e-mail attachment files via NOC router 200 to WAN 100. In addition, e-mail application 245 may acquire and store e-mail messages and attachment files. Application server 240 may also run and manage run-time applications on clients 160 connected to local-area network 120.

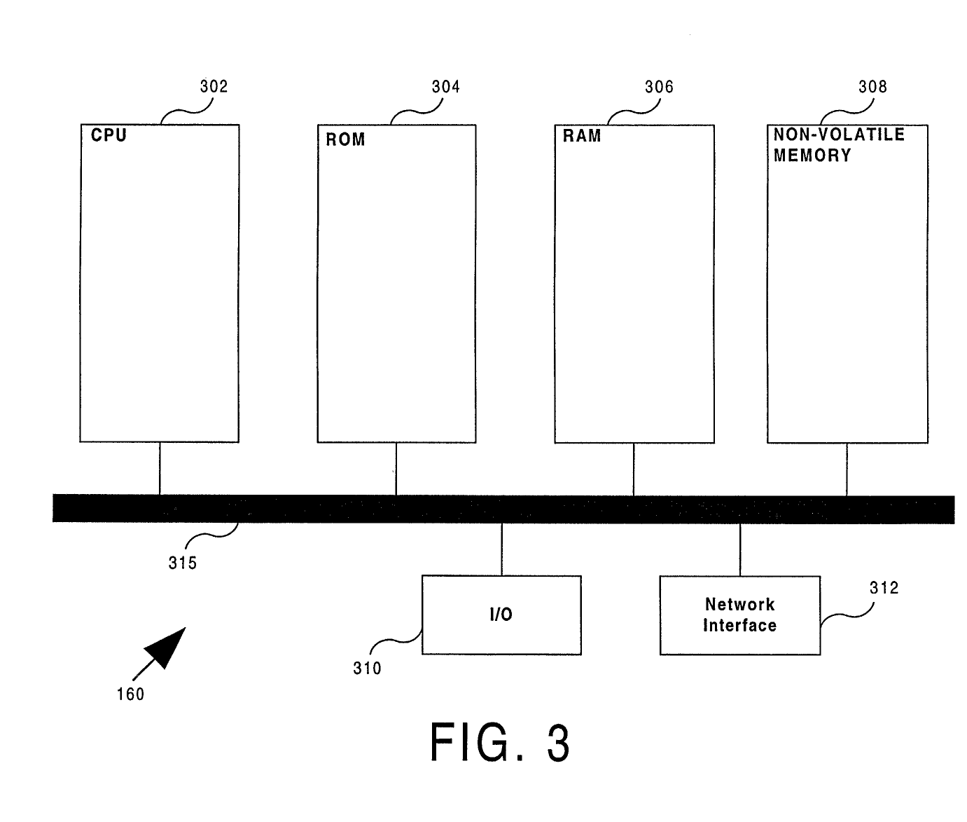

FIG. 3 is a block diagram of one embodiment for an architecture of a client 160. Referring to FIG. 3, CPU 302 is coupled via a bus 315 to a variety of memory structures and input/output 310. The memory structures may include read only memory (ROM) 304, random access memory (RAM) 306, and/or non-volatile memory 308. In one embodiment, CPU 302 is also coupled via bus 315 to a network interface 312. Network interface 312 is used to communicate between client 160 and network operations center 150 and a variety of other clients 160. Network interface 312 is coupled to the wide area network 100 or to local-area network 120 by any of a variety of means such as, for example, a telephone connection via modem, a DSL line, or the like.

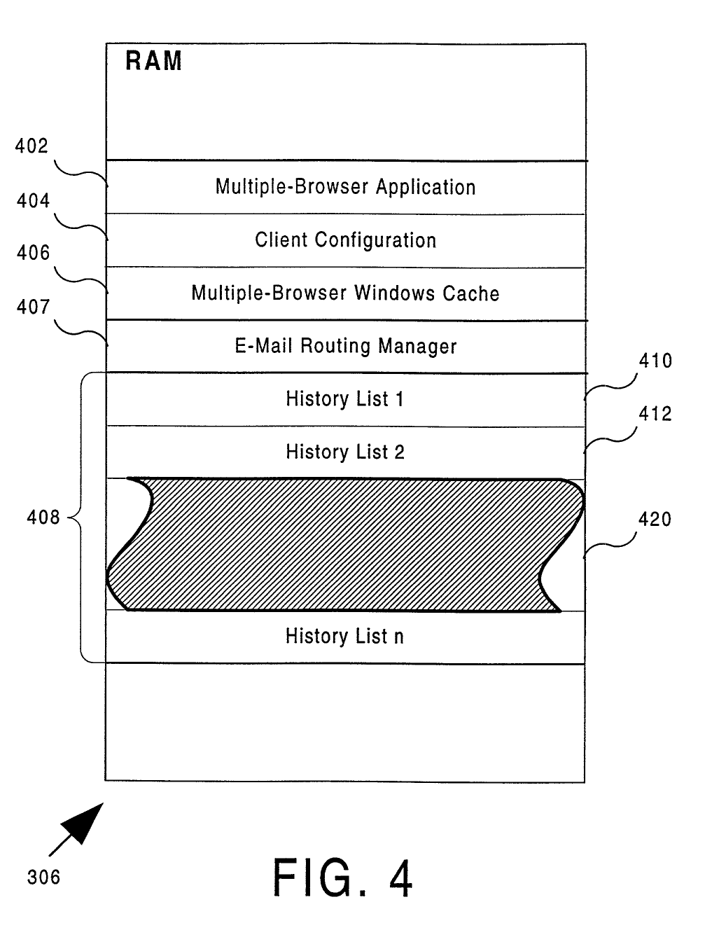

FIG. 4 is a block diagram of one embodiment for random access memory (RAM) 306. Referring to FIG. 4, RAM 306 contains multiple-browser application 402, client configuration 404, multiple-browser windows cache 406, e-mail routing manager 407, and history list 408. In one embodiment, history list 408 contains history list 1 (410) through history list n (420). Multiple-browser application 402 communicates with network operations center 150 or with a proxy server maintained within local-area network 120 to manage the multiple browsers and applications accessed by the user. All navigation between windows applications and web applications is controlled by multiple-browser application 402. Client configuration 404 contains information to allow a user to sign-on to the system and to configure client 160. Client configuration 404 may contain user identification and/or passwords for sign-on and a configuration profile for specifically allowing access to various applications and web pages maintained on client 160, network operations center 150, and/or local-area network 120.

Multiple-browser windows cache 406 contains a number of content windows accessed by the user As the user navigates within the system, various areas of the system are opened and displayed in specific windows on the desktop. The content of the window accessed or displayed by the system is maintained in the cache 406. For example, web pages accessed through a web browser program are opened within a browser window. Each web page content is cached in multiple-browser windows cache 406. In one embodiment, multiple-browser application 402 may open application, media, content, browser, and other windows and save the content of the pages accessed for each of these types of windows in cache 406. In one embodiment, the content for each window may be maintained in separate areas within the cache 406. In an alternate embodiment, individual caches may be maintained for the individual windows.

E-mail routing manager 407 includes a series of instructions which are executable by CPU 302 to determine the type of file of an e-mail attachment file and to route the attachment file to the appropriate window for the file type. In one embodiment, e-mail routing manager 407 only routes non-text attachment files. For example, if the attachment file is a video clip, e-mail routing manager routes the attachment to the billboard window and displays the video clip within the window. In one embodiment, the attachment file is routed and displayed when received. In an alternate embodiment, e-mail routing manager notifies the user that a message has been received. In this alternate embodiment, the attachment file is routed and displayed on-demand of the user. In one embodiment, e-mail routing manager 407 may log an entry into the appropriate history list 408 for the application the attachment file is routed to. The entry may be logged at the time of routing or when the user accesses the attachment file.

A history list 408 is maintained for each of the windows supported by the client configuration 404. In one embodiment, each history list 408 may contain an entry indicating the page of information displayed, the window it came from, and the location of the content in cache 406. In an alternate embodiment, any suitable information may be maintained. In one embodiment, a history list 408 may be maintained for each window type stored in multiple-browser windows cache 406. In addition, a separate history list 408 may be maintained for each application accessed within each window. For example, a history list 408 may be maintained for access to a browser, a chat room, and application tools. Application tools may consist of a number of local applications such as, for example, word processing, graphics programs, and multi-media programs. The local applications are maintained on and processed by client 160. In one embodiment, a separate history list 408 may be maintained for the browser, chat room, and for each of the application programs within the application tools. In one embodiment, an entry for each application accessed under application tools may be entered into a browser bookmark file.

After the user has signed-on to the system, multiple-browser application 402 configures the client 160 based upon information within client configuration 404 in order that the user may access a variety of applications (such as, for example, a browser, chat, and the applications within application tools). As the user navigates within a given application, the pages or windows of the application are displayed within a main, content window on the display screen and the content of each page is saved in cache 406. In addition, an entry is entered into the appropriate history list 408 for the application. The user may move between the various applications by manipulating or “clicking” navigation buttons on the desktop. Whenever the user navigates back to a previously accessed application, multiple-browser application 402 accesses the history list 408 for the application, retrieves the content for the history list 408 entry from cache 406, and displays the content within the content window. Thus, the system provides an integrated, webcentric desktop management system that seamlessly manages the state of each application active within the system and allows the user to move effortlessly from one application to another.

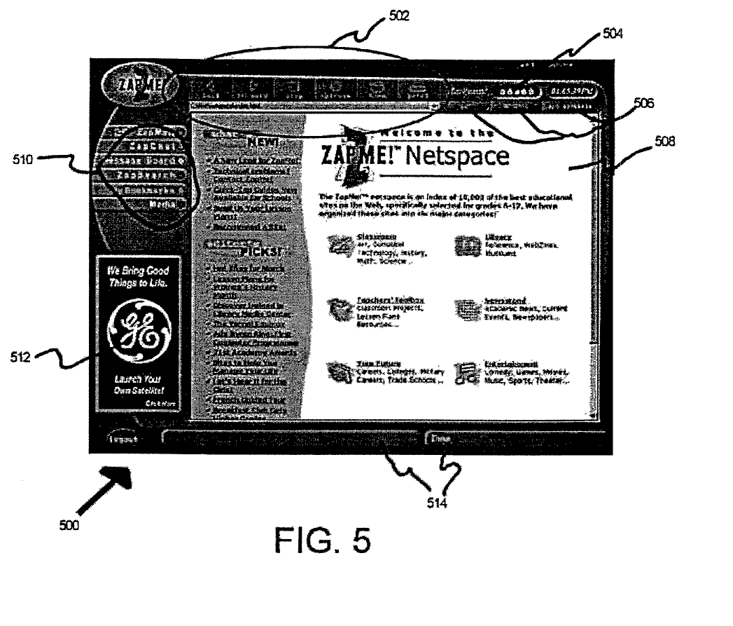

FIG. 5 is a layout of one embodiment for a graphical user interface (GUI) 500 of an e-mail attachment file routing system. In one embodiment, GUI 500 is displayed upon client 160 and is configured based on pre-defined user privileges and the terminal privileges. In one embodiment, GUI 500 provides the gateway by which a user accesses both local and remote resources. Thus, the configuration of GUI 500 determines the resources to which the user has access.

In one embodiment, navigation buttons 502 provide graphical “buttons” that allow a user to perform certain operations. Navigation buttons 502 may include, for example, “back,” “forward,” and “stop” buttons for browser control as well as “save,” “open,” and “print” buttons for general application control. In alternate embodiments, fewer, and/or different buttons and commands may be included in navigation buttons 502 (e.g. the ability to type in a URL, history navigation button, and bookmark button) .

In one embodiment, applications/edit menus 506 provides application selection control and general editing control for multiple applications within content window 508. For example, applications/edit menus 506 may include a list of all local and/or remote applications available to the user of the terminal on which GUI 500 is displayed. For example, from the tools menu, the user may select an application to use. The edit portion provides general editing commands such as “cut,” “copy,” and “paste” for the user to move data between available applications.

In one embodiment, points meter 504 provides a summary of incentive points or other points schemes available to the user. An incentive points management scheme is described in greater detail in U.S. patent application Ser. No. 09/XXX,XXX (P004) entitled “METHOD AND APPARATUS FOR INCENTIVE POINTS MANAGEMENT,” which is assigned to the corporate assignee of the present invention.

Content window 508 provides space for the user to interact with the resources accessed. For example, if a word processing application is being accessed, content window 508 displays the word processing application within content window 508 when the application is activated. The user may switch between applications and move data between applications that are available on the terminal using applications/edit menus 506 should the current user have sufficient privileges to do so on the current terminal. If a browser application is being used, content window 508 is used to display a browser window.

In one embodiment, feature and channel buttons 510 provide access to features (e.g., e-mail, chat rooms, message boards, bookmarks) and channels (e.g., educational topics, news topics) available to the user. Feature and channel buttons 510 are configured based on the session privileges such that only the features and channels available to or associated with the user appear. Feature and channel buttons may also control what is displayed in content window 508.

In one embodiment, dynamic billboard 512 provides advertising and/or other information to the user while the user is using an application or browser. One embodiment of an advertising implementation for dynamic billboard 512 is disclosed in U.S. patent application Ser. No. 09/XXX,XXX (P003) entitled “MICRO-TARGETED DIRECT ADVERSING,” which is assigned to the corporate assignee of the present invention. In alternate embodiments, dynamic billboard 512 may be used for other purposes such as, for example, video conferencing, instant messaging, distance learning/instruction, news updates, or other uses.

In one embodiment, messaging windows 514 display messages to the user. For example, an instructor may send messages to students, a user of one terminal may send a message to a user of another terminal, a system administrator may send messages to a user or a group of users, or the system may send a notification that the user has received e-mail. Messaging windows 514 are used for messages that are independent of content window 508, so long as such messages are allowed by the current session privileges.

Upon receipt of a non-text attachment file, e-mail routing manager 425 routes the attachment file to the appropriate window for the type of file. The attachment file may be displayed immediately within a window within GUI 500 or may be extracted and sent to another application for further processing. For example, if the attachment is a graphic file and a graphics application is displayed in content window 508, e-mail routing manager 425 may send the graphic attachment file to content window 508 for immediate display. On the other hand, if the attachment file is an audio file, the audio attachment file may be sent to a voicemail application for processing. As another example, if the attachment file is an advertisement, the advertisement file may be routed to the billboard application and displayed within billboard window 512.

In one embodiment, if the attachment file is not displayed immediately, e-mail routing manager 407 creates a notice which is sent to and displayed on billboard window 512. In an alternate embodiment, a notice may be displayed on messaging window 514.

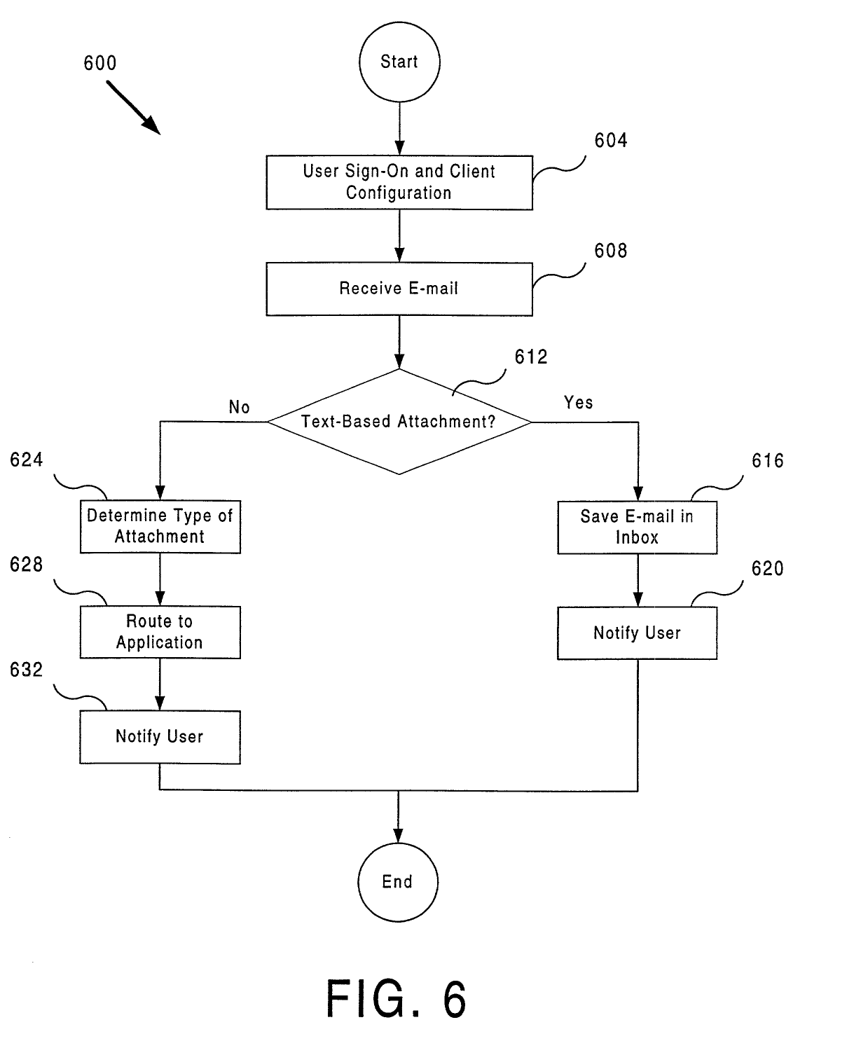

FIG. 6 is a flow diagram of one embodiment for routing e-mail attachment files. Initially at processing block 604, a user signs-on to the system. In one embodiment, the user signs on using a user identification and password combination. After the user's sign-on is verified, client 160 is configured for the particular identification/password combination. Configuration settings are maintained in client configuration 404 and allow or deny access to a number of applications maintained on network operations center 150 and/or client 160. In addition, applications may be maintained on a proxy server located within local-area network 120. In one embodiment, applications comprise browser, chat, e-mail, advertisements, network operations center content, and client applications. Client applications are application programs maintained on client 160 such as, for example, word processing, graphics programs, educational programs, and the like.

After the user has signed-on to the system and the configuration has been set, the system waits to receive an e-mail message. At processing block 608, the system receives and e-mail message. At processing block 612, e-mail routing manager 407 determines if an attachment file is present and if the attachment file is a text-based file. If the attachment file is a text-based file, e-mail routing manager 407 saves the e-mail in e-mail application 245 inbox at processing block 616. At processing block 620, the user is notified that a new e-mail message has been received. In one embodiment, a notification may be displayed in messaging window 514 that an e-mail message has been received.

If at processing block 612, it is determined that a non-text-based attachment file is present, processing continues at processing block 624. At processing block 624, e-mail routing manager 407 determines the type of attachment file present. In one embodiment, e-mail routing manager 407 checks the filename extension (.doc, mpg, etc.) and matches the extension to a known list of types. In an alternate embodiment, manager 407 examines the content of each attached file to determine the nature of the attachment. By looking at the actual content, manager 407 can determine the nature of the attached file. For example, an e-mail may arrive with three attachments: hello.mpg, dad.wav, and list.doc. By scanning the contents of the hello.mpg file, manager 407 may determine that the file is an MPEG video file and route the file to the video player application. The file dad.wav is an audio file and may be routed to a player which immediately plays the audio, or it may be routed to an “answering machine” application for later review. The file list.doc is a MS Word document and is routed (or saved) to the user's local hard disk. The attachments are intelligently routed (copied/saved/played) to the appropriate application for processing when they arrive without user intervention. The attachment file may be, for example, a video file, an audio file, a multimedia file, a graphics file, or any applicable type of file.

At processing block 628, e-mail routing manager 407 routes the attachment file to the appropriate application depending upon the type of file. For example, if the attachment file is a graphics file, e-mail routing manager 407 may route the file to a graphics display application or to dynamic billboard 512 for display. In one embodiment, e-mail routing program 407 may create a history list 408 entry corresponding to the application that the attachment file is routed to. In one embodiment, the attachment file is automatically routed to the appropriate application upon receipt. In an alternate embodiment, e-mail routing manager 407 may notify the user that an attachment file has been received and wait to route the file on demand of the user.

At processing block 632, e-mail routing manager 407 notifies the user that an attachment file has been routed to an appropriate application. In one embodiment, e-mail routing manager 407 creates and sends a message to dynamic billboard 512. The system then displays the message on dynamic billboard 512 that a message has been received. In one embodiment, the user may then access the message by “clicking” within the dynamic billboard 512 window. The system responsively initiates the appropriate application program to access the message.

For example, if a voicemail message has been received as an attachment file, e-mail routing manager 407 routes the message to the voicemail application and creates an entry in the appropriate history list 408. E-mail routing manager 407 creates a message that notifies the user that a voicemail message has been received and sends the message to the dynamic billboard 512 where the message is displayed. Once the user “clicks” on the dynamic billboard 512 message, the voicemail application is initiated and the user may listen to the voicemail message.

The invention has been described in conjunction with the preferred embodiment. It is evident that numerous alternatives, modifications, variations and uses will be apparent to those skilled in the art in light of the foregoing description.

What is claimed is:

1. A method of routing e-mail attachment files within a computer system, the method comprising:
ascertaining the type of file for the attachment file based upon content of the attachment file; and
if the attachment file is not a text-based file, routing the attachment file to an appropriate application program based upon the type of the attachment file.

2. The method of claim 1 further comprising:
launching the application program in response to the receipt of the attachment file.

3. The method of claim 1 wherein routing of the attachment file is performed automatically upon receipt of the file.

4. The method of claim 1 wherein routing of the attachment file further comprises:
receiving notice that an attachment file has been received; and
sending the file to the appropriate application program in response to a trigger event.

5. The method of claim 4 wherein the trigger event is selected from the group consisting of accessing a feature button, accessing a navigation button, clicking on an application window, and accessing an application menu.

6. The method of claim 1 further comprising:
sending a notification message to dynamic billboard; and
accessing the attachment file by accessing the dynamic billboard.

7. The method of claim 1 further comprising:
maintaining a history list corresponding to the application program.

8. The method of claim 1 wherein the file type of the attachment file is selected from the group consisting of video file type, audio file type, multimedia file type, and graphics file type.

9. A system for routing e-mail attachment files within a computer system, the system comprising:
means for ascertaining the type of file for the attachment file based upon content of the attachment file; and
if the attachment file is not a text-based file, means for routing the attachment file to an appropriate application program based upon the type of the attachment file.

10. The system of claim 9 further comprising:
means for launching the application program in response to the receipt of the attachment file.

11. The system of claim 9 wherein means for routing of the attachment file further comprises:
means for receiving notice that an attachment file has been received; and
means for sending the file to the appropriate application program in response to a trigger event.

12. The system of claim 9 further comprising:
means for maintaining a history list corresponding to the application program.

13. An article of manufacture having one or more computer-readable medium with executable instructions therein, which when executed by a processing device, causes the processing device to:
ascertain the type of file for an attachment file based upon content of the attachment file; and
if the attachment file is not a text-based file type, route the attachment file to an appropriate application program based upon the type of the attachment file.

14. The medium of claim 13 further configured to:
maintain a history list corresponding to the application program.

15. The medium of claim 13 further configured to:
launch the application program in response to the receipt of the attachment file.

16. The medium of claim 13 further configured to:
receive notice that an attachment file has been received; and
send the file to the appropriate application program in response to a trigger event.

17. A system for routing e-mail attachment files within a computer system, the system comprising:
an e-mail routing manager configured to ascertain the type of file for the attachment file based upon content of the attachment file; and
if the attachment file is not a text-based file, the routing manager routes the attachment file to an appropriate application program based upon the type of the attachment file.

18. The system of claim 17 wherein the routing manager is configured to automatically route the attachment file upon receipt of the file.

19. The system of claim 17 wherein the routing manager is further configured to:
receive notice that an attachment file has been received; and
send the attachment file to the appropriate application program in response to a trigger event.

20. The system of claim 19 wherein the trigger event is selected from the group consisting of accessing a feature button, accessing a navigation button, clicking on an application window, and accessing an application menu.

21. The system of claim 17 further comprising:
a multiple-browser application configured to maintain a history list corresponding to the application program.

22. The system of claim 17 wherein the multiple-browser application is further configured to launch the application program in response to the receipt of the attachment file.

23. The system of claim 17 wherein the file type of the attachment file is selected from the group consisting of video file type, audio file type, multimedia file type, and graphics file type.
